(19) United States
(12) Patent Application Publication
(10) Pub. No.: US 2024/0375069 A1
(43) Pub. Date: Nov. 14, 2024

(54) MIXING DEVICE FOR FLUID PRODUCTS CONTAINED IN CONTAINERS

(71) Applicant: HERO EUROPE S.R.L., Salmour (IT)

(72) Inventors: Paolo SACCHET, Salmour (IT); Alessandro SACCHET, Salmour (IT)

(21) Appl. No.: 18/699,023

(22) PCT Filed: Sep. 21, 2022
(86) PCT No.: PCT/IT2022/050254

§ 371 Date: Apr. 5, 2024

(30) Foreign Application Priority Data
Oct. 20, 2021 (IT) 102021000026975

(51) Int. Cl. B01F 29/10; B01F 29/00; B01F 29/34; B01F 29/62; B01F 29/80; B01F 35/32; B01F 101/30

(52) U.S. Cl. CPC B01F 29/10; B01F 29/34; B01F 29/4032; B01F 29/4033; B01F 29/40351; B01F 29/40362; B01F 29/62; B01F 29/80; B01F 35/3204; B01F 2101/30; B01F 2215/0422

(57) ABSTRACT

Some embodiments relate to a mixing device for fluid products contained in containers is described, comprising a plurality of cups configured to house the containers of the liquids to be mixed inside them and operated by means of a train of gears by motor means in so as to rotate simultaneously with a revolution motion around a vertical axis and with a rotation motion around an axis of the cups which is inclined by an angle with respect to the vertical axis, the mixing device also comprising a counterweight fixed to a support of the cups on the opposite side with respect to the vertical axis.

### CROSS-REFERENCE TO RELATED APPLICATIONS

This application is a national phase filing under 35 C.F.R. § 371 of and claims priority to PCT Patent Application No. PCT/IT2022/050254, filed on Sep. 21, 2022, which claims the priority benefit under 35 U.S.C. § 119 of Italian Patent Application No. 102021000026975, filed on Oct. 20, 2021, the contents of which are hereby incorporated in their entireties by reference.

### BACKGROUND

The present invention refers to a mixing device for fluid products.

In particular, the invention refers to a mixing device for fluid products such as paints, enamels or liquids in general formed by several components that must be stirred or mixed within substantially rigid containers to mix.

Mixing devices for fluid products contained in containers are known, of the vortex type, wherein the container containing the fluids to be mixed is rotated around at least one axis, preferably around two axes with rotational and revolving movements; typically, the container is at least rotated about its own vertical axis. Examples of conventional vortex mixers are described in U.S. Pat. Nos. 3,542,344, 4,235,553 and 4,497,581. These known vortex mixers are constructed to accommodate a particular size and shape of the container. For example, vortex mixers for paint are typically constructed to accommodate a conventional one-gallon cylindrical container. Since paint is generally also sold in cylindrical quart containers, adapters have been developed to hold quart containers in these vortex paint mixers.

However, these mixing devices for fluid products contained in containers are not satisfactory and have the problem that they are not designed to mix fluid products contained in containers of reduced capacity, for example for half-pint samples.

Another problem with mixing devices for known fluid products is that they do not allow the mixing times to be optimized when used with containers of reduced capacity such as half-pint containers.

Document US-A-5 352 037 describes a mixing device for fluid products according to the preamble of Claim 1.

### SUMMARY

Object of the present invention is solving the aforesaid prior art problems by providing a mixing device for fluid products contained in containers which allows mixing fluid products contained in containers of reduced capacity, optimizing mixing times.

It is understood that all attached claims are an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by some preferred embodiments, provided by way of non-limiting example, with reference to the attached drawings, in which:

FIG. 1 shows an isometric view of an embodiment of the mixing device for fluid products contained in containers according to the present invention;

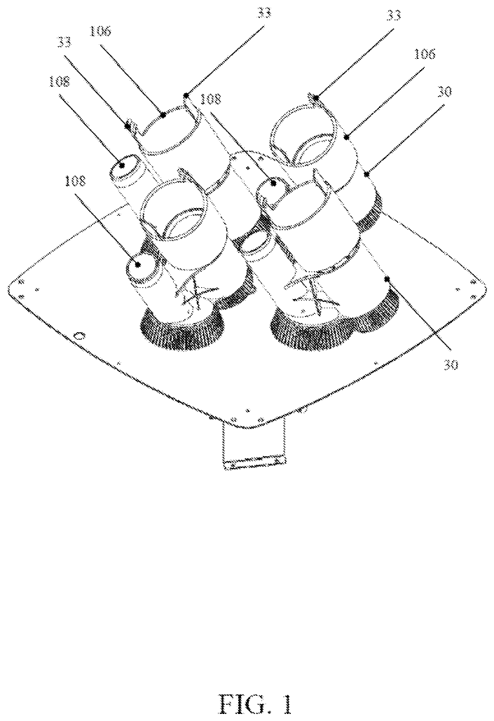

FIG. 2 shows an isometric sectional view of an embodiment of the mixing device for fluid products contained in containers according to the present invention;

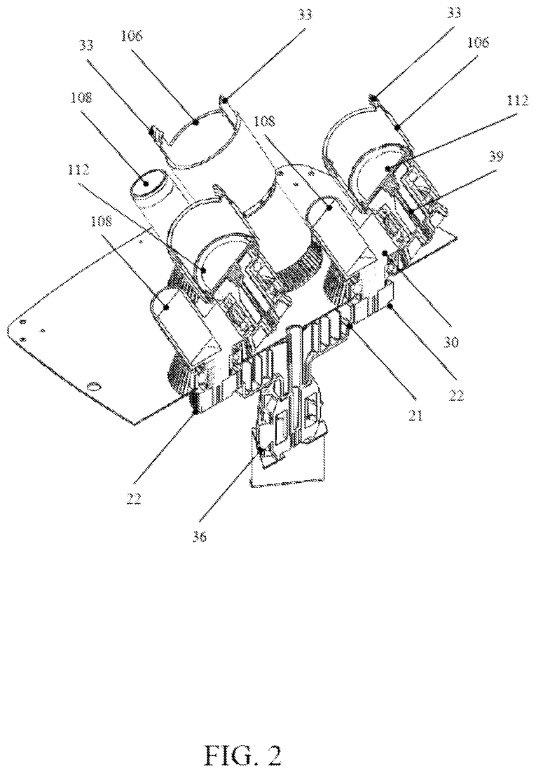

FIG. 3 shows a perspective view of an embodiment of the mixing device for fluid products contained in containers according to the present invention which highlights the gear train used;

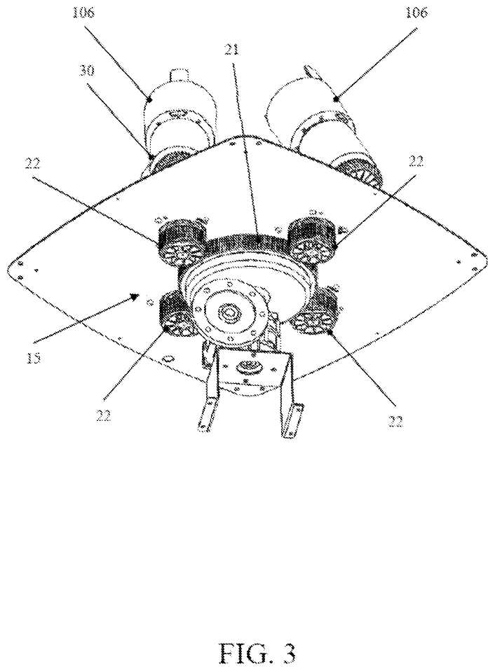

FIG. 4 shows a sectional side view of an embodiment of the mixing device for fluid products contained in containers according to the present invention;

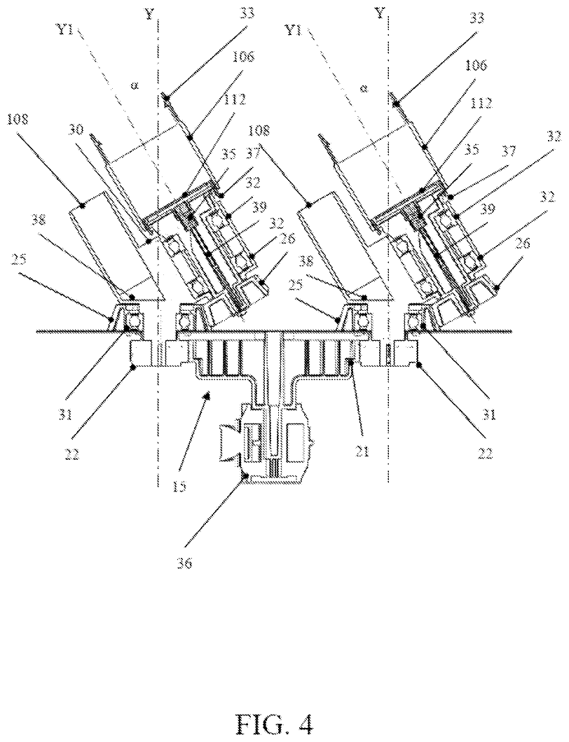

FIG. 5 shows an isometric view of an embodiment of the mixing device for fluid products contained in containers according to the present invention.

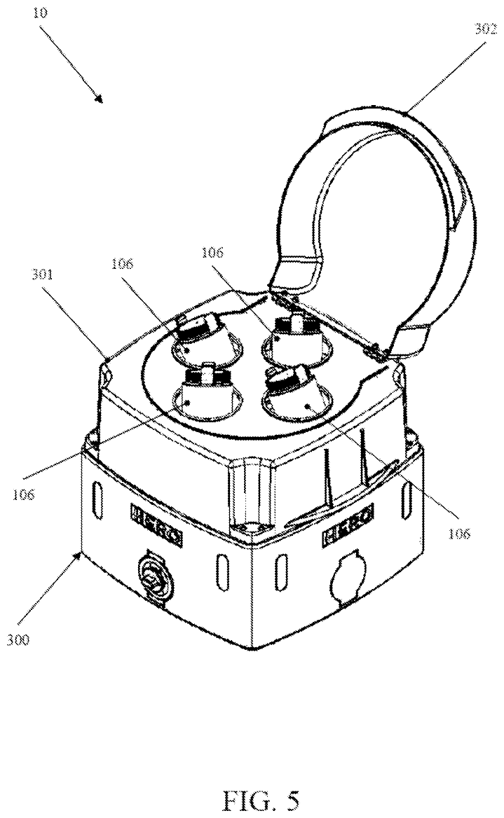

### DETAILED DESCRIPTION

With reference to the figures, the mixing device 10 for fluid products contained in containers, in particular for mixing paints, enamels or liquids in general formed by several components, comprises a plurality of cups 106, preferably four cups 106, configured to accommodate them inside the containers of the liquids to be mixed and operated by means of a train of gears 15 by motor means, preferably by an electric motor, so as to rotate simultaneously with a revolution motion around a vertical axis Y and with a rotation motion around an axis Y1 of the cups 106 which is inclined by an angle α with respect to the vertical axis Y.

Preferably, the gear train 15 comprises a transmission toothed wheel 21, driven by the electric motor, which transmits motion to a plurality of driven toothed wheels 22 each fixed to a support 30 of each cup 106 so as to make it rotate with the revolution motion around the vertical rotation axis Y of the toothed wheel 22.

The rotation motion of the cup 106 around its axis Y1 is transmitted by the toothed wheel 22, fixed to the corresponding support 30, by means of a pair of bevel wheels 25, 26 comprising a first bevel wheel 25 connected to the support 30 in a rotating manner around the vertical axis Y, for example by means of a ball bearing 31, and a second bevel wheel 26 fixed to the cup 106 which in turn is connected to the support 30 in a rotating way, for example by means of at least one ball bearing 32, around the axis Y1 of cup 106.

The mixing device 10 for fluid products of the invention also comprises a counterweight 108 fixed to the support 30 on the opposite side with respect to the vertical axis Y; the counterweight 108 is preferably inserted in a seat 38 obtained in the support 30; for example, the counterweight 108 is a metal element inserted in a seat 38 preferably cylindrical in shape and inclined by an angle α equal to the angle of inclination of the axis Y1 of the cup 106, which is also cylindrical in shape.

Preferably, the cup 106 comprises an adapter 112 at the bottom on which the container of the liquids to be mixed rests, connected by elastic means, for example a helical compression spring 35, to the cup 106 and/or to the second conical wheel 26 to hold the container of the liquids to be mixed in the working position, blocked by fins 33 made at the mouth of the cup 106, so as to keep the mixing device 10 stable during its operation.

Preferably, the adapter 112 comprises side flaps 37 comprising a step for attaching the adapter 112 to the cup 106, and is fixed to the second bevel wheel 26 by means of a shaft 39, for example by means of a screw.

Preferably, the transmission toothed wheel 21 is driven by the electric motor by means of a reducer 36, and the electric motor is activated by a timer, for example of the mechanical type.

Preferably, the angle α of inclination of the Y1 axis of the cup 106 is 30° to obtain a distribution of the moving liquid masses such as to optimize mixing and to have a position of the center of gravity of the single cup 106 which reduces vibrations to a minimum, both in the presence of the container and in the case of no-load operation.

In a preferred embodiment of the invention, the mixing device 10 for fluid products comprises an external protective casing 300 which prevents access to the moving gear train 15, comprising a cap 301 and a re-closable lid 302 equipped with a sensor which cuts off the power supply to the motor when the cover 302 is opened.

Advantageously, the mixing device 10 for fluid products of the invention allows mixing fluid products contained in containers of reduced capacity, optimizing mixing times.

Another advantage of the mixing device 10 for fluid products according to the invention is that of being compact, with weight and dimensions that allow it to be housed on a work table and to have reduced vibrations during operation.

1. A mixing device for fluid products contained in containers comprising a plurality of cups configured to house the containers of liquids to be mixed inside the mixing device and operated by means of a train of gears by motor means so as to rotate simultaneously with a revolution motion around a vertical axis and with a rotation motion around an axis of the cups which is inclined by an angle with respect to the vertical axis, the mixing device further comprising a counterweight fixed to a support of each cup on the opposite side with respect to the vertical axis wherein the gear train comprises a transmission toothed wheel which transmits motion to a plurality of driven toothed wheels each fixed to the support of each cup so as to make the cup rotate with a revolving motion around the vertical axis of rotation of the toothed wheel.

2. The mixing device for fluid products of claim 1, comprising four cups.

3. (canceled)

4. The mixing device for fluid products of claim 1, wherein the rotation motion of the cup around its axis is transmitted by the toothed wheel, fixed to the corresponding support, by means of a pair of bevel wheels comprising a first bevel wheel connected to the support rotating around the vertical axis, and a second bevel wheel fixed to the cup which in turn is connected to the support in a rotating manner around the axis of the cup.

5. The mixing device for fluid products of claim 1, wherein the counterweight is inserted in a seat obtained in the support.

6. The mixing device for fluid products of claim 1, wherein the counterweight is inserted in a seat and is inclined by an angle equal to the angle of inclination axis of the cup.

7. The mixing device for fluid products of claim 1, wherein on the cup comprises an adapter at the bottom on which the container of the liquids to be mixed rests, connected by means elastic bands to the cup and/or to the second conical wheel to hold the container of the liquids to be mixed in the working position.

8. The m mixing device for fluid products of claim 7, wherein the adapter comprises lateral flaps comprising a step for hooking the adapter to the cup, and the adapter is fixed to the second bevel wheel.

9. The mixing device for fluid products of claim 1, wherein the angle of inclination of the axis of the cup is 30°.
